(19) United States
(12) Patent Application Publication
(10) Pub. No.: US 2016/0010456 A1
(43) Pub. Date: Jan. 14, 2016

(54) METHOD FOR PRODUCING A TUBBING HAVING A THERMOPLASTIC SEALING LAYER

(71) Applicant: SIKA TECHNOLOGY AG, Baar (CH)

(72) Inventors: Martin LINNENBRINK, Apensen (DE); Martin DEMMIG, Quickborn (DE); Josef VON ROTZ, Kerns (CH); Christoph FAH, Zurich (CH)

(73) Assignee: SIKA TECHNOLOGY AG, Baar (CH)

(21) Appl. No.: 14/772,625

(22) PCT Filed: Mar. 6, 2014
(86) PCT No.: PCT/EP2014/054320

§ 371 Date: Sep. 3, 2015

(30) Foreign Application Priority Data
Mar. 12, 2013 (EP) 13158804.8
Mar. 13, 2013 (CH) 00608/13

(51) Int. Cl. E21D 11/04; B29C 65/00; B29C 65/02

(52) U.S. Cl. CPC E21D 11/04; B29C 65/02; B29C 66/0342

(57) ABSTRACT

A method is disclosed for producing a tubbing made of concrete for lining a tunnel, particularly a traffic tunnel, wherein the tubbing has a convexly curved outer surface and a concavely curved inner surface opposite the outer surface. The method can include: a) placing a membrane having a dispersion adhesive layer and a thermoplastic sealing layer onto the outer surface and further onto at least one of the sides of the outer side surfaces of the tubbing facing the outer surface, wherein the dispersion adhesive layer faces the tubbing; b) supplying heat, thus partially melting the dispersion adhesive layer; and c) cooling the dispersion adhesive layer, thus forming an adhesive bond between membrane and the tubbing.

### TECHNICAL FIELD

The present invention relates to a method for producing a tubbing made of concrete for lining a tunnel, particularly a traffic tunnel.

### PRIOR ART

Although applicable to any desired area of construction, the present disclosure and problems that can solve will be explained in greater detail in the following with reference to a traffic tunnel.

In the field of mechanical tunnel construction using the shield drive technique, prefabricated steel-reinforced concrete parts have been used for the inner shell. These prefabricated concrete parts, called “tubbings” in technical jargon, are prefabricated in prefabrication plants, stored for a period of time until they reach the specified concrete strength, and then placed in the tunnel tubes for installation as needed. There, they are picked up by a tubbing setting device, the so-called “erector”, and assembled into a tubbing ring under the protection of the shield of the tunnel drilling machine. After the tunnel drilling machine has advanced while supporting itself with hydraulic jacks against the most recently installed tubbings, a new tubbing ring is fitted in under protection of the shield. In this manner the machine works its way through the soil “tubbing ring by tubbing ring”, wherein the annular gap remaining between the tunnel lining (tubbing ring) and the soil is continuously filled with mortar, for example to prevent subsidence.

Not only standard traffic tunnels, but under specific geological conditions, also so-called supply or disposal tunnels for household, commercial or industrial buildings, which especially in the form of large-diameter collecting or distributing mains serve for central transport of wastewater or fresh water or as cable tunnels for accommodating high-voltage lines, are produced by the tubbing extension method using the above-described segmented construction technique. However, in all these areas of application, whether to maintain perfectly hygienic drinking water quality or to prevent functional breakdowns due to the penetration of soil moisture to the electric conductors, great demands are made on the impermeability and durability of the tubbing lining of the tunnel.

For this reason, up to now a separate, second working step in tunnel construction has been used for final sealing of the concavely curved outer surfaces of the tubbings, facing the exterior tunnel, and/or the production of an additional, second tubbing ring.

In a method described in JP H03-212600, for producing tubbing elements provided with polymer linings, adhesives based on rubber/asphalt mixtures have been used, among other substances. However, the disadvantage of these adhesives is that creep which takes place over a longer time period can lead to a detachment of the polymer lining from the concrete surface. If water penetrates into these cavities, and if the tunnel wall is exposed to temperatures below the freezing point, the result can be damage to the tubbing element.

In the method described in JP 2002-294015, a water-tight membrane made of ethylene vinyl acetate with different contents of vinyl acetate is connected to the concrete surface of a tubbing. This occurs by casting the liquid concrete on the membrane, as a result of which a partial hydrolysis of the vinyl acetate units in the polymer occurs due to the alkalinity of the liquid concrete. The vinyl alcohol units so released then as a result ensure adhesion of the membrane to the concrete. However, the disadvantage of this procedure is the limitation to the use of the special ethylene vinyl acetate mixture, which does not have sealing properties that are suitable for all applications. In addition, the membrane has to be brought in contact with liquid concrete, so that the membrane can become damaged during subsequent storage and transport of the tubbing.

Due to their size, tubbing rings require a lot of space in the manufacturing process during the individual process steps, particularly if they require temporary storage. Shortening the manufacturing process, particularly the storage times, is therefore of great interest.

### PRESENTATION OF THE INVENTION

The object of the present invention therefore is to improve the production of tubbings so that they are protected and sealed from the moisture on the outer side of the tubbing ring, and at the same time to ensure a rapid manufacturing process, in particular with short temporary storage times.

According to the invention, this is achieved by the features of the first claim.

The core of the invention is a method for producing a tubbing made of concrete for lining a tunnel, in particular a traffic tunnel, wherein the tubbing 1 has a convexly shaped outer surface 2 and a concavely curved inner surface 3 opposite the outer surface 2, comprising the steps

a) placing a membrane 4 having a dispersion adhesion layer 5 and a thermoplastic sealing layer 6 onto the outer surface 2 and, furthermore, at least partially onto at least one side, in particular all the sides of the outer side surfaces (7, 8) of the tubbing facing the outer surface 2, wherein the dispersion adhesive layer 5 faces the tubbing 1;

b) supplying heat, thus partially melting the dispersion adhesive layer 5;

c) cooling the dispersion adhesive layer 5, thus forming an adhesive bond between membrane 4 and the tubbing 1.

The tubbing has an annular segment-shaped structure with a concavely curved inner surface, which is directed in the installed state towards the tunnel interior, and an opposite, convexly curved outer surface, which is directed towards the surrounding ground in the installed state. Laterally, these two surfaces are connected via four additional surfaces, two long side surfaces, which, in the installed state, are in contact with the corresponding long side surfaces of the adjacent tubbings of the same tubbing ring, and two end side surfaces, which, in the installed state, are in contact with the corresponding end side surfaces of the adjacent tubbings of an adjoining tubbing ring.

The method can advantageously be further improved by attaching, preferably by adhesion, the membrane at first on the outer surface so that the membrane has at least one edge protruding over the convex outer surface of the tubbing, and in that the dispersion adhesive layer is subsequently partially melted in the area of the protruding edge of the membrane after step c) optionally by supplying heat, and cooled, thus forming an adhesive bond between membrane (4) and the outer side surface of the tubbing or of the membrane of an adjoining tubbing.

Using the tubbings produced by the method according to the invention, no separate second work step for the final sealing of the concavely curved outer surface of the tubbing facing the tunnel exterior is required. In addition, a possible second tubbing ring is omitted. Moreover, tubbings with smaller wall thicknesses can be used/produced, because they are far superior to conventional tubbings in terms of water tightness and resistance to corrosive ground water. Both features lead to a reduction of the space requirement of the tunnel wall and as a result to a gain of interior space and to a reduction of the construction material required. Furthermore, the tubbings produced according to the invention allow the use of alternative, less water-tight and less corrosion-resistant concrete types. Moreover, tubbing rings made of tubbings that were produced by the method according to the invention have excellent seepage protection and leak-tightness.

It has been shown that, by using a dispersion adhesive layer for the formation of an adhesive bond between membrane and the tubbing, after a few minutes strong forces between the bonded substrates can already be transmitted. For example, the grippers (usually vacuum grippers) used in the plant producing the finished concrete part can move the tubbing shortly after the cooling of the dispersion adhesive layer. This rapid buildup of strength is advantageous in that, for the adhesion, no mechanical attachment means such as clamps or the like are needed. Moreover, this allows a rapid manufacturing process with short temporary storage times. Furthermore, after the adhesion of the outer surface, by supplying heat, a deep drawing of the membrane over the outer side surfaces is made possible, as a result of which the need to weld the membrane at the boundary between two outer side surfaces is avoided.

Additional advantageous embodiments of the invention result from the dependent claims.

Additional aspects of the invention are the subject matter of additional independent claims.

### SHORT DESCRIPTION OF THE DRAWING

Below, in reference to the drawings, exemplary embodiments of the invention are explained in further detail.

FIG. 1 shows a lateral cross section through a tubbing.

FIG. 2 shows an additional lateral cross section through a tubbing.

FIGS. 3 and 4 show the steps a) and b) of the method.

Only the elements essential for the immediate understanding of the invention are shown.

### WAY OF CARRYING OUT THE INVENTION

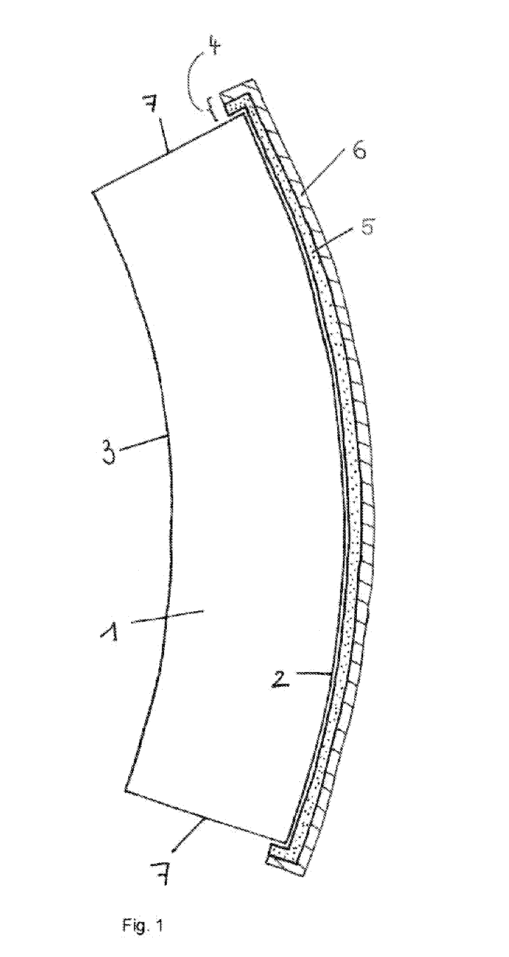

In FIG. 1, a lateral cross section through a tubbing produced according to the invention is shown.

The tubbing 1 is provided with a membrane 4 on its convexly curved outer surface 2.

The membrane comprises a dispersion adhesive layer 5 and a thermoplastic sealing layer 6, wherein the dispersion adhesive layer 5 faces the tubbing 1.

The membrane is arranged over a partial area preferably on at least one side, particularly preferably on all the sides of the outer side surfaces (long side surfaces 7 and end side surfaces 8) facing the outer surface. In FIG. 1, the two long side surfaces 7 are shown. Although it is not preferable, the membrane can, however, also extend over the entire outer side surfaces 7 and 8. This ensures, among other things, an excellent bond of the dispersion adhesive layer, and thus of the membrane, with the tubbing and a high seepage protection level. Moreover, a greater sealing effect is achieved at the butt joints between two tubbings, due to the increase in the contact surface area of the contacting membranes, compared, for example, to a membrane which does not have an arrangement on all the sides of the outer side surfaces facing the outer surface. The use of a reversibly softenable dispersion adhesive thus allows a sealing transitioning into one another of the outer surface and of the outer side surfaces of the tubbing. This sealing can be completed very rapidly, since, after the attachment of the membrane on the convex outer surface, one only has to wait a short time until the adhesive bond has solidified sufficiently. Subsequently, the sealing of the outer side surfaces can be carried out, a process in which, if necessary, the dispersion adhesive can again be partially melted in the area of the edge by supplying heat.

In addition, the protruding edge of the membrane can also be bonded to the membrane of an adjoining tubbing, which also leads to an improved sealing effect.

In addition, the outer and side surfaces can be bonded in a continuous process with the membrane, a process in which one does not wait between the bonding of the outer surface and the side surfaces with the membrane until the adhesive bond between outer surface and membrane has solidified.

Preferably, the dispersion adhesive layer is connected completely to the outer surface 2, in particular by bonding, which leads to an improvement of the seepage protection.

To be as suitable as possible as thermoplastic sealing layer 6, said layer should be as watertight as possible and it should not decompose or be mechanically damaged even after prolonged exposure to water or moisture. Materials that are already used for sealing purposes in building construction and civil engineering are particularly suitable as thermoplastic sealing layer.

It is advantageous if the thermoplastic sealing layer is made of a material with a softening point above 110° C., preferably between 140° C. and 170° C. The thermoplastic sealing layer advantageously should have at least a slight degree of resilience, in order to be able to accommodate stresses caused, for example, by temperature-caused differences in expansion between thermoplastic sealing layer and tubbing, without the thermoplastic sealing layer being damaged or torn and the sealing function of the sealing layer being affected.

The thermoplastic sealing layer preferably comprises a material that is selected from the group consisting of high density polyethylene (HDPE), medium density polyethylene (MDPE), low density polyethylene (LDPE), polyethylene (PE), polypropylene (PP), polyethylene terephthalate (PET), polystyrene (PS), polyvinyl chloride (PVC), polyamides (PA), ethylene vinyl acetate (EVA), chlorosulfonated polyethylene and thermoplastic polyolefins (TPO).

It is particularly preferable if the thermoplastic sealing layer contains polyvinyl chloride (PVC).

The thermoplastic sealing layer preferably consists of more than 50% by weight, particularly preferably more than 80% by weight, of the above-mentioned materials.

In addition, the thermoplastic sealing layer can contain additives and processing agents such as fillers, UV and heat stabilizers, plasticizers, sliding agents, biocides, flame protection agents, antioxidants, pigments such as titanium dioxide or carbon black, for example, and dyes. Such films are referred to as films made of the given material in spite of the fact that they do not consist 100% of a thermoplastic material, that is to say films made of PVC and these additives are referred to as PVC films or soft PVC films although they do not consist of 100% PVC or soft PVC.

As flexible polyvinyl chloride-based thermoplastic sealing layer, it is particularly suitable to use a PVC film conventionally used in the field of the sealing of buildings, in particular a soft PVC film. Such PVC films contain, in particular, plasticizers, typically phthalate plasticizers.

So that they can be used in practice as a sealing layer, it is important that these PVC films are flexible. During the bending or folding of the film, which occurs during the application of the film or also during use, for example, as a result of temperature variations, mechanical stresses caused by walking or driving on the film, for example, the use of rigid PVC films would lead to breaking or at least partially tearing, as a result of which the sealing function could not be ensured. In addition, it is practically unavoidable in practice that the sealing film has to be delivered in the form of rolls at the construction site. However, a rigid PVC cannot be rolled up.

A particularly suitable PVC film is the product Sikaplan® WP 1100-21 HL offered by Sika AG, Switzerland.

The thermoplastic sealing layer advantageously has a layer thickness in the millimeter range, typically between 0.2 and 15 mm, preferably between 1 and 2 mm.

The thermoplastic sealing layer 6 consists preferably of flexible, that is to say bendable, flat films. Thermoplastic sealing layers are produced, for example, by calendaring or extrusion.

Typically, a membrane 4 is produced by applying, for the formation of the dispersion adhesive layer 5, the dispersion adhesive composition, preferably at room temperature, onto the thermoplastic sealing layer and flashing it off or drying it by supplying heat.

The application occurs preferably by squeezing, spraying, painting, stamping, rolling, pouring, brushing, rolling, dipping or extruding.

Preferably, a dispersion adhesive layer 5 is obtained that is non-adhesive at 25° C.

Preferably, a membrane is obtained which can be cut to length as needed, cut off, rolled up or immediately further processed.

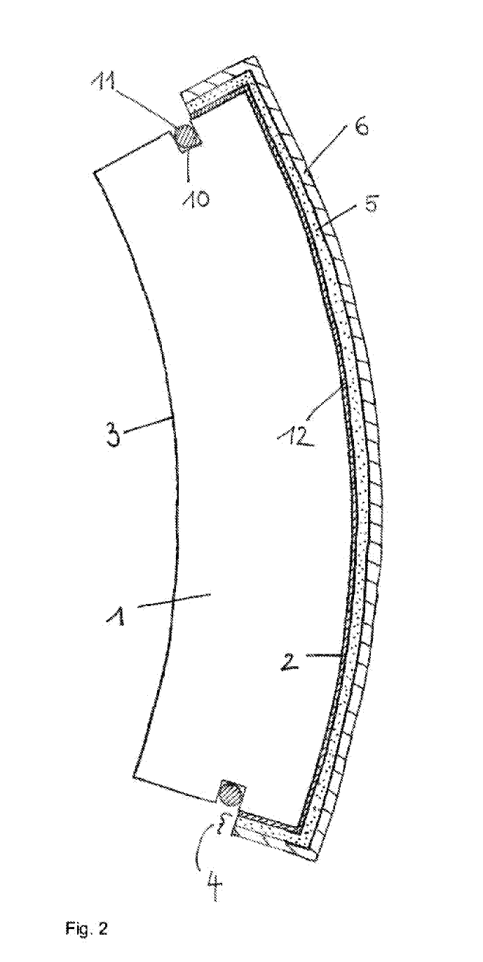

The tubbing preferably has a sealing groove 10 which extends peripherally around the outer side surfaces (7, 8) and in which a sealing body 11 is arranged, as can be seen in FIG. 2. The sealing groove is molded in the tubbing, and a sealing body is located therein, which is typically pressed in. The sealing body 11 is typically a hollow body. Materials that are particularly suitable as material for the sealing body are those known as sealing materials for sealing rings and/or water swellable materials. In the present document, the term “water swellable materials” is understood to mean materials that increase their volume several times when they come in contact with water, typically to between 200 and 1000% of the original volume. In addition to undergoing an increase in volume, certain water swellable materials can also react chemically with water. Examples of such water swellable materials are swelling substances based on polyurethane, in particular silane-modified polymers that cure by moisture to form a resilient product. An additional example of such swelling substances consists of bentonite-butyl rubbers or the acrylic acid-based polymers subsumed under the term “superabsorbents” (Superabsorbent Polymers, SAP), typically copolymers made of acrylic acid and sodium acrylate, for example, from BASF SE, Germany.

The sealing body 11 consists particularly preferably of ethylene-propylene-diene rubber (EPDM).

This is advantageous because, as a result, at the butt joints between two tubbings, an additional sealing barrier for penetrating water is set up and thus a greater sealing effect is achieved.

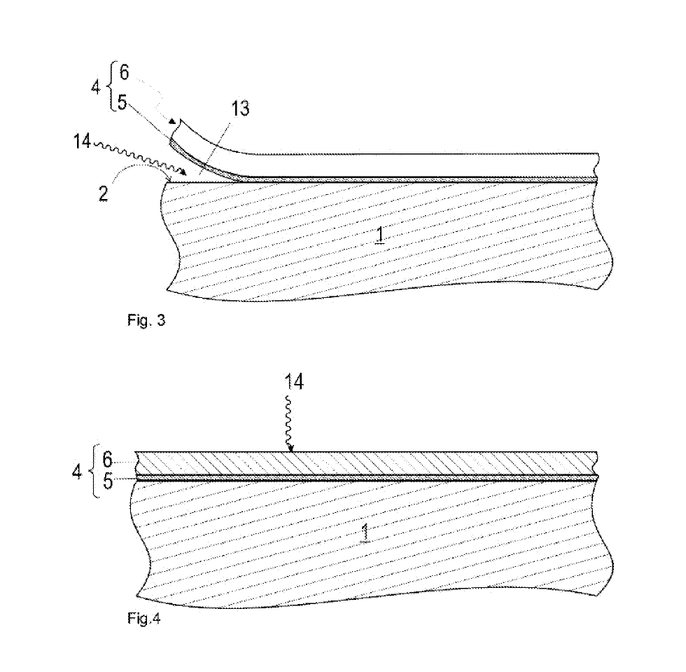

The tubbing preferably has a sealing coating 12 between the outer surface 2 and the hot melt adhesive layer 5, as can be seen in FIG. 2 and FIG. 3. The sealing coating is selected from the group consisting of methacrylate resin, polyester resin, epoxy resin, polyurethane, preferably in the form of a dispersion adhesive, and polyurea. Epoxy resin is particularly preferable as sealing coating. If the coating consists of a dispersion adhesive, it can be the same adhesive as that which forms the dispersion adhesive layer 5 or a dispersion adhesive different therefrom.

Such a sealing coating 12 is advantageous in that, as a result, the tubbing is protected against the penetration of moisture. Moreover, this reinforces the sealing effect of the tubbing. In the production of the tubbing, a great loss of moisture can moreover be prevented during the curing of the green body. The sealing coating 12 is typically applied to the tubbing by spraying or brushing.

Moreover, it is advantageous that the sealing coating 12 is arranged at least partially on all outer side surfaces 7, 8, in particular on the area between the outer surface 2 and the sealing groove 10.

As sealing body 11, one can consider using any materials that are suitable for reducing or preventing the passage of fluids, particularly of water.

The sealing body preferably consists of a thermoplastic or of a thermoplastic elastomer. Thermoplastic elastomers have the advantage that the sealing body as a result has a good resilience with respect to horizontal and vertical shifting, in particular shifting due to mechanical stresses in the construction. A good resilience of the sealing body prevents tearing or detachment of the sealing body and thus a failure of the seal.

In this document, thermoplastic elastomers are understood to mean plastics that combine the mechanical properties of vulcanized elastomers with the processability of thermoplastics. Typically, such thermoplastic elastomers are block copolymers with hard and soft segments or so-called polymer alloys with corresponding thermoplastic and elastomer components.

Additional advantageous materials for sealing bodies are materials selected from the group consisting of acrylate compounds, polyurethane polymers, silane-terminated polymers and polyolefins.

In the present document, “room temperature” is understood to mean a temperature of 25° C.

In the present document, “to partially melt” or “partial melting” the heating of the dispersion adhesive composition to a temperature which is above the so-called crossover temperature (“T_{crossover}”) and which is below the softening point measured using the ring & ball method according to DIN EN 1238.

The crossover temperature, frequently also referred to as flow limit, represents the temperature at which the curves of the loss modulus and storage modulus, measured by DTMA (dynamic mechanical thermal analysis), intersect. In the context of this invention, for the determination of the crossover temperature by DTMA measurements, the following DTMA measurement parameters are used:

Apparatus: Anton Paar MCR 300 SN 616966

Software US V2.3

Stamp: 25 mm plate (smooth surface)

Measuring gap: (Sample thickness) 1 mm

Temperature ramp: 200° C.-90° C. with −1° C./min

Frequency of oscillation: 1 Hz

Gamma amplitudes: 1% (corresponds to 0.8 mrad)

The partial melting typically occurs at a temperature that is substantially, i.e., at least 20° C., in particular at least 30° C., preferably at least 40° C., below the softening point.

Preferably, the dispersion adhesive layer 5 consists of a nonreactive dispersion adhesive composition.

In this document, “nonreactive” dispersion adhesive composition is understood to mean a dispersion adhesive composition which does not comprise polymers that react chemically with one another or with components of the air at room temperature. In particular, such nonreactive dispersion adhesive composition comprise no polymers comprising isocyanate or alkoxysilane or epoxy or (meth) acrylate groups. Thus, the nonreactive dispersion adhesive composition contains, in particular, no epoxies, in particular no solid epoxy resins.

Moreover, nonreactive dispersion adhesive compositions are in the form of dispersions. A “dispersion” represents a heterogeneous mixture of at least two substances that do not dissolve or only barely dissolve in one another or bind chemically to one another and it comprises two phases. In the context of this invention, dispersions are understood to mean such heterogeneous mixtures of a solid (suspension) or of a liquid (emulsion) in another liquid.

The liquid phase of the dispersion is preferably a solvent, in particular an organic solvent with a boiling point at normal pressure below 120° C., preferably below 90° C., or water.

The liquid phase is preferably water. Therefore, the nonreactive dispersion adhesive composition is preferably an aqueous dispersion. The dispersion adhesive composition preferably comprises a liquid phase and a solid phase.

Since the composition is in the form of a dispersion, it is obvious that in this context such a solvent is not capable of completely dissolving the solid of the solid phase or the second liquid. The liquid phase most preferably is water.

On the one hand, nonreactive dispersion adhesive compositions on polyester-polyol-based polyurethane dispersions as well as, on the other hand, dispersions containing copolymers obtained from the radical polymerization of at least two different monomers having at least one, preferably one, unsaturated C═C double bond, have been found to be particularly suitable.

Polyester-polyol-based polyurethanes are produced preferably by reacting polyisocyanates and polyester polyols that are preferably solid at room temperature. The polyester polyols themselves are prepared by the polycondensation of hydroxycarboxylic acids or by the polycondensation of aliphatic and/or aromatic polycarboxylic acids with dihydric or polyhydric alcohols, preferably of short-chain polyols, preferably diols or triols having a molecular weight of less than 250 g/mol, in particular less than 150 g/mol, or polyether polyols and dicarboxylic acids or dicarboxylic acid anhydrides, in a stoichiometry that is suitable so that the reaction products comprise hydroxyl groups and thus are polyester polyols. It is particularly preferable to use as polyester polyols condensation products of ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, glycerol, 1,1,1-trimethylolpropane with organic di- or tricarboxylic acids, in particular dicarboxylic acids, or their anhydrides or esters, such as, for example, succinic acid, glutaric acid, adipic acid, trimethyladipic acid, suberic acid, azelaic acid, sebacic acid, maleic acid, fumaric acid, phthalic acid, phthalic acid anhydride, isophthalic acid, terephthalic acid, trimellitic acid and trimellitic acid anhydride.

Particularly suitable monomers for the production of copolymers are selected from the group consisting of (meth) acrylic acid, (meth) acrylic acid esters, (meth) acrylic acid amides, ethylene, propylene, butylene, isobutylene, butadiene, isoprene, styrene, acrylonitrile, vinyl esters and allyl ethers. Such copolymers are produced in particular by radical emulsion polymerization or solvent polymerization. Due to the reaction mechanism, the polymerization occurs via the double bonds. Therefore, the copolymers also no longer have any (meth) acrylic acid, (meth) acrylic acid ester or (meth) acrylic acid amide groups.

Ethylene/vinyl acetate copolymers are considered particularly preferable as such copolymers.

The nonreactive dispersion adhesive composition preferably is or contains a polyurethane dispersion, in particular a polyester-polyol-based polyurethane dispersion. Such a dispersion adhesive can be obtained, for example, under the commercial name SikaTherm®-4100 from Sika.

It has been shown to be particularly suitable that the nonreactive dispersion adhesive composition contains a polyurethane dispersion, in particular a polyester-polyol-based polyurethane dispersion, as well as at least one copolymer obtained from the radical polymerization of at least two monomers with at least one, preferably one, unsaturated C═C double bond, preferably an ethylene/vinyl acetate copolymer, wherein the weight ratio between polyurethane dispersion and copolymer of at least two monomers with an unsaturated C═C double bond has a value of 100:0-30:70, in particular of 50:50.

The proportion of polyester-polyol-based polyurethane and copolymer obtained from the radical polymerization of at least two monomers with at least one, preferably one, unsaturated C═C double bond in the weight of the entire nonreactive dispersion adhesive composition is preferably between 30 and 70% by weight, in particular between 50 and 40% by weight.

The nonreactive dispersion adhesive composition preferably comprises a liquid phase and a solid phase.

The solid phase comprises, in particular, a polymer that is solid at room temperature.

Moreover, it is preferable that the solid of the nonreactive dispersion adhesive composition has a melting temperature of 60-120° C., in particular of 70-90° C.

Polymers that are solid at room temperature are, in particular, the already mentioned and preferred polyester-polyol-based polyurethanes and copolymers which are obtained from the radical polymerization of at least two monomers with at least one, preferably one, unsaturated C═C double bond.

The nonreactive dispersion adhesive composition is preferably an aqueous dispersion.

In the case of such an aqueous dispersion, the water proportion in the weight of the entire nonreactive dispersion adhesive composition is preferably between 30 and 70% by weight, in particular between 40 and 60% by weight.

The solid or the second liquid phase and the liquid phase are produced in the manner conventionally used in production. An in-situ production is preferred particularly preferably, i.e., precursors which lead to the solid or the second liquid phase are added to the liquid phase under intensive stirring and reacted with one another. A very suitable method here is the emulsion polymerization of at least two monomers with an unsaturated C═C double bond in the liquid phase, which can lead directly to a desired dispersion.

Sometimes it is also advantageous to mix two or more dispersions that are already in the form of dispersions with one another.

The production of such nonreactive dispersion adhesive compositions occurs in a manner known to the person skilled in the art. In order to obtain the best possible dispersions, it is preferred to use high-speed mixers in the production, in particular rotor-stator dispersers.

Moreover, the nonreactive dispersion adhesive composition can comprise additional components. Suitable additional components are, in particular, components that are selected from the group comprising plasticizers, adhesion promoting agents, UV absorbents, UV and heat stabilizers, optical brighteners, fungicides, pigments, dyes, fillers, and drying agents.

The dispersion adhesive layer typically has an application weight of 50 to 1000 g/m², in particular 200 to 800 g/m², preferably 200 to 400 g/m². The layer thickness of the hot melt adhesive layer is preferably between 50 and 500 micrometer, in particular between 100 and 300 micrometer.

The application of the nonreactive dispersion adhesive composition can occur over the entire surface, in a grid pattern or in a special pattern.

Subsequently, the nonreactive dispersion adhesive composition is flashed off. Here, a membrane 4 provided with a flashed off dispersion adhesive layer 5 is formed, which is tack-free at room temperature.

The effect of the flashing off is that the solvent or the water evaporates. The so-called flash off time, i.e., the time that passes from the application of the nonreactive dispersion adhesive composition until the composition is dry, i.e., tack-free, is preferably 10 to 240 minutes, in particular 30 to 90 minutes.

The flashing off can be accelerated by a flashing off means. As flashing off means it is possible to use, for example, a blower, in particular an air blower, preferably using heated air, or an IR radiation source. The flashing off can occur at room temperature or at slightly elevated temperature, in particular at a temperature below 60° C.

The resulting flashed off membrane (4) coated with dispersion adhesive composition can now be cut to length as needed, cut off, rolled up or immediately processed further. The rolls with the coated membranes can now be stored or transported as needed.

The production of the membrane occurs preferably in an industrial process in a film producing plant, and the coated membrane reaches the construction site preferably in the form of a coated membrane to be taken from a roll for use. This Said roll is advantageous in that the flashing off does not have to take place at the construction site, which—if the dispersion adhesive composition is solvent-based—is advantageous in terms of occupational hygiene, safety technology and ecotoxicology, since the evaporating solvent can be captured more simply and efficiently in a film producing plant and as a result the possibility of the solvent reaching the environment and igniting is prevented. In addition, there is no need to wait at the construction site until the dispersion composition has flashed off, which thus considerably speeds up the work process on the construction site. Due to the property that the flashed off dispersion adhesive composition is tack-free, the coated film can be rolled up easily and thus stored in the form of a roll in a space saving manner and transported and unrolled again as needed. Preferably, individual layers on the roll do not bond to one another, i.e., preferably no blocking of the roll occurs during storage, particularly in the case of prolonged storage. However, in some—not preferred—cases, it may be recommendable to prevent blocking completely by placing a separation paper, in particular a siliconized separation paper, on the coated membrane before rolling up.

The membrane can shift on the surface of the tubbing due to the tack-free nature of the flashed off dispersion adhesive composition. However, due to the net weight of the membrane coated with adhesive, a certain minimum force is required for this shifting. This is advantageous because undesired shifting can thus be prevented. Therefore, for example, in the case of sloping surfaces, an undesired slipping away or blowing away due to slight winds can be largely prevented. The minimum force required for shifting to occur can, on the one hand, be adjusted by selecting the additives (for example, fillers) or the film thickness, or, on the other hand, the surface structure of the flashed off dispersion adhesive composition can be significantly influenced the adhesive friction. Thus, for example, the adhesive friction can be increased by a rough adhesive surface, which, for example, is the result of an uneven adhesive application or a grid-like adhesive application.

The method according to the invention comprises the step

a) placing a membrane 4 having a dispersion adhesive layer 5 and a thermoplastic adhesive layer 6 onto the outer surface 2 and further onto sides of the outer side surfaces 7, 8 of the tubbing that face at least the outer surface 2, wherein the dispersion adhesive layer 5 faces the tubbing 1.

Preferably, the membrane 4 is placed on all the sides of the outer side surfaces 7, 8 of the tubbing facing the outer surface 2.

In an additional step b) of the method, heat is supplied, so that the dispersion adhesive layer 5 partially melts.

In step b), the supplying of heat is preferably carried out in such a manner that the temperature of the hot melt adhesive layer 5 does not exceed a temperature which is at least 20° C., preferably at least 30° C., in particular at least 40° C. below the melting point, i.e., below the softening point of the dispersion adhesive layer.

The supplying of heat in step b) can occur preferably during the placement of the membrane 4 in step a), in particular into the gap 13 formed during the placement between dispersion adhesive layer 5 and the tubbing 1.

In a further embodiment, in step b), the heat is supplied on the side of the membrane 4 opposite from the dispersion adhesive layer 5, and it is transmitted via the thermoplastic sealing layer 6 onto the dispersion adhesive layer 5. Preferably, the membrane 4 is deep drawn in the process after the bonding of the outer surface 2 by renewed supplying of heat at least partially over the outer side surfaces. As a result, a continuous surfaces/edges bond forms.

The supplying of heat can occur by hot air, flame, induction or dielectric heating. The supplying of heat occurs preferably in such a manner that the heat does not exert excessive negative stress on, or destroy, the dispersion adhesive layer 5, the thermoplastic sealing layer 6 or the outer surface 2, respectively the sides of the outer side surfaces 7, 8 of the tubbing facing the outer surface.

Since the dispersion adhesive composition partially melts, the dispersion adhesive composition is at least partially capable of flowing, as a result of which a close contact with the surface of the tubbing is ensured. The contact of the dispersion adhesive composition with the surface of the tubbing can be improved by pressure applied via a roller, for example, which is preferable in the context of the invention.

In particular, the heating of the adhesive occurs here at an adhesive temperature of 60 to 120° C., preferably 70 to 90° C.

In a step c) downstream of step b), the dispersion adhesive layer 5 is cooled with formation of an adhesive bond between membrane 4 and the tubbing 1. This cooling occurs typically without additional auxiliary means. However, in some cases it may be appropriate and advantageous to speed up the cooling, if the tubbing is to be stressed or walked on already after a particularly short time. This can occur, for example, by cooling the membrane or the tubbing by means of a cooling means, for example, by a blower, in particular an air blower.

The supplying of heat, and thus the partial melting of the dispersion adhesive layer 5 in step b) can occur in such a manner that
in one step, the membrane 4 is placed only onto the outer surface 2 and the steps b) and c) are carried out, and subsequently
in an additional step, the membrane 4 is placed onto all the sides of the outer side surfaces 7, 8 facing the outer surface,

and the steps b) and c) are carried out. In such a method, the use of a nonreactive dispersion adhesive composition is particularly advantageous, because said composition can be melted repeatedly and cooled again, and the adhesive bond between membrane and the tubbing is nevertheless guaranteed. For example, if, during the bonding of the outer surface, areas of the dispersion adhesive layer are melted when heat is applied, which, in the subsequent step, come to lie on one of the sides of the outer side surfaces 7, 8 facing the outer surface and become connected to said side.

Furthermore, it can be advantageous, among other things, if the membrane 4 which is placed onto the outer surface 2 and the membrane 4 which is placed on all the sides of the outer side surfaces 7, 8 facing the outer surface are two separate membranes. However, said membranes have to be connected, in particular, welded or bonded to one another in such a manner that the water tightness remains ensured.

Moreover, it can be particularly advantageous if the membrane 4 which is placed onto the outer surface 2 and the membrane 4 which is placed on all the sides of the outer side surfaces 7, 8 facing the outer surface are one and the same membrane.

Furthermore, it can be advantageous if, before and/or during the cooling of the dispersion adhesive layer in step c), in particular between steps b) and c), the membrane is pressed onto the tubbing, in particular with a roller or a roll.

FIGS. 3 and 4 show steps a) and b) of the process.

In FIG. 3, a first embodiment is represented. Here, in step a), the membrane 4 is placed on the outer surface 2 of the tubbing, where the dispersion adhesive layer 5 faces the tubbing 1. In particular, if the dispersion adhesive layer is a tack-free dispersion adhesive layer, said layer can be moved on the outer surface, which allows, for example, a final positioning of the membrane.

Moreover, FIG. 3 shows a variant of step b). Here, in step b), during the placement of the dispersion adhesive layer in step a), the heat is supplied into the gap 13 formed between dispersion adhesive layer and the outer surface or outer side surfaces of the tubbing during the placement. Due to the heat, a partial melting of the dispersion adhesive composition occurs. As a result, the dispersion adhesive composition becomes soft or slightly tacky and it can become connected to the tubbing. In the subsequent step c), the dispersion adhesive composition is cooled again, as a result of which an adhesive bonding between membrane and the tubbing occurs.

FIG. 4 represents a further embodiment. Here heat is supplied by means of a heat source 14 in step b) on the side of the membrane 4 opposite from the dispersion adhesive layer 5 and transmitted via the thermoplastic sealing layer 6 onto the dispersion adhesive layer 5. Due to the heat, a partial melting of the dispersion adhesive layer 5 occurs. As a result, the dispersion adhesive composition becomes at least partially fluid and can come in contact with the tubbing. In the subsequent step c), the dispersion adhesive composition is cooled again, as a result of which an adhesive bonding between membrane and tubbing occurs.

The tubbing is suitable preferably for use for tunnel constructions having a diameter of 0.5-50 m.

An additional aspect of the invention relates to a construction, in particular a tunnel, containing a tubbing according to the invention.

### EXAMPLES

The invention is also illustrated below in reference to examples.

A tunnel membrane Sikaplan® WP 1100-21 HL, which can be obtained from Sika AG, Switzerland, was coated by means of a squeegee with a nonreactive polyurethane dispersion adhesive SikaTherm®-4100 (nonreactive polyurethane dispersion adhesive) obtainable from Sika Automotive GmbH, Germany. The application weight of SikaTherm®-4100 was 250 g/m². SikaTherm®-4100 has a crossover temperature of approximately 110° C. determined by DTMA according to the method described above. The resulting membrane was heated for 10 minutes in a Mathys oven at 80° C. Subsequently, the coated membranes were applied by supplying heat between slab and membrane (Leister heat gun (Electron), 500° C.) onto an optionally pretreated garden slab (conventional walking paving slab based on concrete).

In a first sample, the garden slab was also coated by means of a roller with SikaTherm®-4100 (application weight 250 g/m²) and flashed off for 30 minutes at 23° C.

In a second sample, the garden slab was coated as in the case of the first sample, but dried for 10 minutes at 70° C.

For the third sample, the dispersion adhesive was applied onto the slab and membrane with a notched trowel. The slab and the membrane were subsequently dried for 30 min. at 70° C.

The fourth sample was produced analogously to the first sample but the dispersion adhesive was not also applied to the garden slab.

The fifth sample was produced analogously to the second sample. However, the bonding occurred by supplying heat on the side of the membrane facing away from the adhesive layer.

After cooling each sample for 1-2 minutes, a very satisfactory strength was observed in a manual test.

For the samples 1 to 3, the peeling strength and the adhesive tensile strength (90° pull-off angle in each case) were determined, for the purpose of which the specimens were first stored for 7 days at 23° C.

The peeling strength was determined based on DIN EN 1372. In comparison to this standard, the following changes were made: instead of a fiber cement slab, a garden slab made of concrete was used. The samples are not checked in a roller peel test. Instead, the membrane was glued with heating onto the entire surface area of garden slab with the dimensions of 20×40 cm. Subsequently, in each case a strip with the dimensions of 5×20 cm was cut out parallel to the width using a carpet knife. The strip was placed in the middle beneath the tensile tension test machine and the garden slab was attached. Subsequently, the force with which the strip can be pulled off at an angle of 90° was determined. The values indicated in Table 1 are average values from five individual measurements.

The adhesive tensile strength was determined based on SIA 271. In comparison to this standard, the following changes were made: As substrate, a garden slab with the dimensions of 20×40 cm made of concrete was used. The membrane was glued with heating over the entire surface area onto this slab. Subsequently, a test stamp with a diameter of 50 mm was attached using an instant adhesive on the membrane. After the curing of the adhesive, the test value was determined at a pull-off speed of 100 mm/min.

The results of these measurements are represented in the following Table 1:

TABLE 1

| | Peeling strength | Adhesive tensile strength |
|---|---|---|
| | [N/50 mm] | [N/mm²] |
| Sample 1 | 43 | 0.99 |
| Sample 2 | 195 | Not determined |
| Sample 3 | 20 | 0.31 |

### LIST OF REFERENCE NUMERALS

1 Tubbing
2 Convexly curved outer surface
3 Concavely curved inner surface
4 Membrane
5 Dispersion adhesive layer
6 Thermoplastic sealing layer
7 Long side surface
8 End side surface
10 Sealing groove extending peripherally around the outer side surfaces in the form of a frame
11 Sealing body
12 Sealing coating
13 Gap
14 Heat source

1. Method for producing a tubbing made of concrete for lining a tunnel, wherein the tubbing has a convexly curved outer surface and a concavely curved inner surface opposite the outer surface, the method comprising:
a) placing a membrane having a dispersion adhesion layer and a thermoplastic sealing layer onto the outer surface and further at least partially onto at least one, of the sides of the outer side surfaces of the tubbing facing the outer surface, wherein the dispersion adhesive layer faces the tubbing;
b) supplying heat, to partially melt the dispersion adhesive layer; and
c) cooling the dispersion adhesive layer, to form an adhesive bond between membrane and the tubbing.

2. Method according to claim 1, comprising:
attaching the membrane to the outer surface in such a manner that the membrane has at least one edge that protrudes over the convex outer surface of the tubbing;
subsequently partially melting the dispersion adhesive layer in an area of the protruding edge of the membrane after step c) optionally by supplying heat; and
cooling the dispersion adhesive layer to form an adhesive bond between the membrane and the outer side surface of the tubbing or of the membrane of an adjoining tubbing.

3. Method according to claim 1, wherein the tubbing has a sealing groove which extends peripherally around the outer side surfaces, in which a sealing body is arranged.

4. Method according to claim 1, wherein the sealing layer is placed partially, onto all the sides of the outer side surfaces of the tubbing facing the outer surface.

5. Method according to claim 1, wherein the thermoplastic sealing layer contains polyvinyl chloride.

6. Method according to claim 1, wherein the tubbing has a sealing coating between the outer surface and the dispersion adhesive layer, wherein the sealing coating is selected from the group consisting of: methacrylate resin, polyester resin, epoxy resin, polyurethane, preferably in the form of a dispersion adhesive, and polyurea.

7. Method according to claim 1, wherein the sealing coating is further arranged at least partially on all the outer side surfaces.

8. Method according to claim 1, wherein the dispersion adhesive in the dispersion adhesive layer is a polyurethane dispersion adhesive.

9. Method according to, claim 1, wherein the dispersion adhesive layer contains a copolymer which is obtained from the radical polymerization of at least two monomers having at least one, unsaturated C═C double bond.

10. Method according to claim 1, wherein the dispersion adhesive layer contains a dispersion adhesive which has a melting temperature in the range from 60 to 120° C.

11. Method according to claim 1, wherein the dispersion adhesive layer has an application weight of 50 to 1000 g/m2.

12. Method according to claim 1, wherein, in step b), the supplying of heat is performed during the placement of the membrane in step a), into the gap formed between dispersion adhesive layer and the tubbing during the placing.

13. Method according to claim 1, wherein in step b), the supplying of heat is performed on the side of the membrane located opposite from the dispersion adhesive layer and the heat is transmitted via the thermoplastic sealing layer onto the dispersion adhesive layer, and, the membrane is deep drawn after the bonding of the outer surface by renewed supplying of heat at least partially over the outer side surfaces, so that a continuous surfaces/edges bonding occurs.

14. Method according to claim 1, wherein, in step b), the supplying of heat is performed in such a manner that the dispersion adhesive layer does not exceed a temperature which is at least 20° C., below the melting point of the dispersion adhesive layer.

15. Construction, in particular a tunnel, containing a tubbing obtained by a method according to claim 1.

16. Method according to claim 3, wherein the sealing layer is placed up to the sealing groove, onto all the sides of the outer side surfaces of the tubbing facing the outer surface.

17. Method according to claim 1, wherein the dispersion adhesive in the dispersion adhesive layer is an aqueous dispersion.

18. Method according to claim 1, wherein the dispersion adhesive layer contains a copolymer which is obtained from the radical polymerization of at least two monomers having one, unsaturated C═C double bond, which is an ethylene/vinyl acetate copolymer.

19. Method according to claim 1, wherein the dispersion adhesive layer contains a dispersion adhesive which has a melting temperature in the range from 70 to 90° C.

20. Method according to claim 19, wherein the dispersion adhesive layer has an application weight of 200 to 400 g/m2, and wherein, in step b), the supplying of heat is performed in such a manner that the dispersion adhesive layer does not exceed a temperature which is at least 30° C., below the melting point of the dispersion adhesive layer.
